(19) United States
(12) Patent Application Publication
(10) Pub. No.: US 2023/0267842 A1
(43) Pub. Date: Aug. 24, 2023

(54) SYSTEM AND METHOD FOR OPTIMIZATION OF MISSION PLANNING OF MULTI-UAV NETWORK FOR DATA COLLECTION AND COMMUNICATION RELAY

(71) Applicant: Electronics and Telecommunications Research Institute, Daejeon (KR)

(72) Inventor: Ui Hwan CHOI, Daejeon (KR)

(73) Assignee: Electronics and Telecommunications Research Institute, Daejeon (KR)

(21) Appl. No.: 17/869,024

(22) Filed: Jul. 20, 2022

(30) Foreign Application Priority Data
Feb. 21, 2022 (KR) 10-2022-0022379

(51) Int. Cl. G08G 5/00; H04B 7/185; B64C 39/02

(52) U.S. Cl. CPC G08G 5/0034; B64C 39/024; H04B 7/18504; B64C 2201/122; B64C 2201/123

(57) ABSTRACT

Disclosed are a method and a system for optimization of mission planning of a multi-UAV network for data collection and communication relay, which can perform optimization of an operation concept for an ad-hoc network based collaboration data collection mission, optimization of flight paths and data collection order of data collection UAVs, flight paths of communication relay UAVs, dynamic communication network topology, and optimization of high-capacity data transmission/reception bitrate scheduling.

### CROSS-REFERENCE TO RELATED APPLICATIONS

This application claims the benefit under 35 USC § 119(a) of Korean Patent Application No. 10-2022-0022379, filed on Feb. 21, 2022 in the Korean Intellectual Property Office, the entire disclosure of which is incorporated herein by reference for all purposes.

### BACKGROUND

### 1. Technical Field

The present disclosure relates to a system and a method for optimization of mission planning of a multi unmanned aerial vehicle (UAV) network for data collection and communication relay, and particularly, to a system and a method for optimization of mission planning of a multi-UAV network for data collection and communication relay, which enable a data collection mission within a wide area by utilizing a multi-UAV mounted with observation/communication relay mission equipment even in an operating environment having a poor communication infrastructure, and which can relieve an operational burden of control personnel by providing an optimization algorithm for automation of complicated multi-UAV mission planning, through the operation concept for an ad-hoc network based collaboration data collection mission, optimization of flight paths and data collection order of data collection UAVs, flight paths of communication relay UAVs, dynamic communication network topology, and optimization of high-capacity data transmission/reception bitrate scheduling.

### 2. Related Art

With the development of UAV crafting and flight control technology, high-performance observation mission equipment and communication device have been mounted on a UAV to be operated. Accordingly, the UAV has been spotlighted as a low-cost and high-efficiency data collection (observation) platform. Further, a technical development for effectively performing a data collection mission in a wide area in a shorter time by organically utilizing a plurality of UAVs has been actively under progress. Since the UAV is a platform of which the flight time is limited due to battery capacity limits, there is a need for a UAV mission planning optimization technology that automatically determines an effective flight path and the data collection order on behalf of the control personnel. Further, for a smooth data collection mission, a stable communication link between a ground station and a UAV is required, and even in a UAV mission planning process, a communication quality coverage or the like is reflected.

However, in real UAV operating environments, such as a mountain range, marine environment, area of natural disaster, and battlefield, it may be difficult to utilize the existing communication infrastructure. To cope with this, an independent ad-hoc network based UAV communication that is not dependent on the existing RF-based or cellular-based communication technology may be utilized as an alternative. However, the multi-UAV mission planning technology in consideration of the ad-hoc communication network environment has not been known much as compared to the need. The reason is that complexity of the problem to be solved by the algorithm is abruptly increased in case that complicated ad-hoc communication related technology elements, such as presence of a plurality of communication nodes (UAVs) moving at high speed, dynamic communication network topology change, communication connectivity security in consideration of wireless communication radius limits, complicated routing protocol, bandwidth limit management, and multi-hop technology, are reflected in the UAV mission planning/scheduling automation algorithm, and thus it is difficult to get the solution within a desired time.

Accordingly, there has been a need for a technology which can automatize and optimize the complicated multi-UAV mission planning as well as enabling the data collection mission in a wide area by utilizing a plurality of UAVs.

### RELATED ART DOCUMENT

### Patent Document

Korean Registered Patent No. 10-2076225

### SUMMARY

In order to solve the above problem, the disclosure proposes a method and a system for optimization of mission planning of a multi-UAV network for data collection and communication relay, which enable a data collection mission within a wide area by utilizing a multi-UAV mounted with observation/communication relay mission equipment even in an operating environment having a poor communication infrastructure, and which can relieve an operational burden of control personnel by providing an optimization algorithm for automation of complicated multi-UAV mission planning, through the operation concept for an ad-hoc network based collaboration data collection mission, optimization of flight paths and data collection order of data collection UAVs, flight paths of communication relay UAVs, dynamic communication network topology, and optimization of high-capacity data transmission/reception bitrate scheduling.

According to an embodiment of the present disclosure, a method for optimization of mission planning of a multi-UAV network for data collection and communication relay may include: defining data collection mission information and parameters; optimizing mission planning of a plurality of data collection UAVs; and optimizing mission planning of a plurality of communication relay UAVs.

In an embodiment, the defining the data collection mission information and the parameters may include: configuring basic environment information of the data collection mission information; and configuring a variable among the UAV, communication, and energy.

In an embodiment, the defining the data collection mission information and the parameters may include: defining the number of the data collection UAVs and the communication relay UAVs; defining the number and locations of data collection points; and defining a location of a ground control station.

In an embodiment, the optimizing the mission planning of the plurality of data collection UAVs may include: determining a data collection order of each of the data collection UAVs based on a minimum mission end time or a minimum flight distance of the data collection UAV; and generating a flight path of each of the data collection UAVs in accordance with a determined data collection order.

In an embodiment, the determining the data collection order of each of the data collection UAVs based on the minimum mission end time or the minimum flight distance of the data collection UAV may include: determining a visit order of allocated data collection points for each of the data collection UAVs by applying a multi-vehicle routing problem solving algorithm (mVRP solver).

In an embodiment, the generating the flight path of each of the data collection UAVs in accordance with the determined data collection order may include: generating the flight path of each of the data collection UAVs based on a maximum movement speed, a decision making time interval, and a required data collection time of each of the data collection UAVs.

In an embodiment, the flight path may be set information of locations of each of the data collection UAVs for each predetermined time unit or set information of movement path points of each of the data collection UAVs.

In an embodiment, the optimizing the mission planning of the plurality of data collection UAVs may include: calculating and determining a flight path of each of the data relay UAVs so as to satisfy a minimum energy consumption based on the generated flight path of each of the data collection UAVs, calculating a communication network topology, and scheduling a dynamic data flow; and optimizing a minimum energy path of each of the communication relay UAVs.

In an embodiment, the calculating and determining the flight path of each of the data relay UAVs so as to satisfy the minimum energy consumption based on the generated flight path of each of the data collection UAVs, calculating the communication network topology, and scheduling the dynamic data flow may include: dividing and formalizing a problem into a mixed-integer linear programming (MILP) problem and a non-linear optimization problem.

In an embodiment, the dividing and formalizing the problem into the mixed-integer linear programming (MILP) problem and the non-linear optimization problem may include: fixing the flight path of each of the communication relay UAVs, and determining a dynamic communication network variable having the minimum energy consumption; fixing a dynamic communication network of each of the communication relay UAVs, and determining a flight path having the minimum energy consumption; and repeating the determining the dynamic communication network variable and the determining the flight path.

In an embodiment, the optimizing the mission planning of the plurality of communication relay UAVs may further include: visualizing as a graph and outputting the result of the repeating the determining the dynamic communication network variable and the determining the flight path.

According to another embodiment of the present disclosure, a system for optimization of mission planning of a multi-UAV network for data collection and communication relay may include: a mission information definer configured to define data collection mission information and parameters; a data collection UAV mission planning optimizer configured to optimize mission planning of a plurality of data collection UAVs; and a communication relay UAV mission planning optimizer configured to optimize mission planning of a plurality of communication relay UAVs.

In an embodiment, the plurality of communication relay UAVs may be connected to one another in a row, the communication relay UAV at a first location may be connected to a ground control station, and the communication relay UAV at a last location may be individually connected to a cluster composed of the plurality of data collection UAVs.

In an embodiment, the plurality of data collection UAVs and the plurality of communication relay UAVs may communicate with each other based on an ad-hoc network.

According to still another embodiment of the present disclosure, a system for optimization of mission planning of a multi-UAV network for data collection and communication relay may include: a mission information definer configured to define data collection mission information and parameters; a data collection UAV mission planning optimizer configured to optimize mission planning of a plurality of data collection UAVs communicating with each other based on an ad-hoc network; and a communication relay UAV mission planning optimizer configured to optimize mission planning of a plurality of communication relay UAVs communicating with each other based on the ad-hoc network.

According to an aspect of the present disclosure, the data collection mission within the wide area becomes possible by utilizing the multi-UAV mounted with the observation/communication relay mission equipment even in the operating environment having poor communication infrastructure, and the operational burden of the control personnel can be relieved by providing the optimization algorithm for automation of the complicated multi-UAV mission planning.

Further, according to an aspect of the present disclosure, the optimization of the flight paths and the data collection order of the data collection UAVs, the flight paths of the communication relay UAVs, the dynamic communication network topology, and the optimization of the high-capacity data transmission/reception bitrate scheduling, of which the technology in the related art is unable to take charge, can be integrally performed through the present disclosure.

### BRIEF DESCRIPTION OF THE DRAWINGS

FIG. 1 is a diagram explaining the concept of a method for optimization of mission planning of a multi-UAV network for data collection and communication relay according to the present disclosure.

FIG. 2 is a diagram illustrating a method for optimization of mission planning of a multi-UAV network for data collection and communication relay in sequential order according to the present disclosure.

FIGS. 3A and 3B are a diagram illustrating a screen for generating flight paths of data collection UAVs.

FIGS. 4A, 4B, 4C and 4D are a diagram illustrating the results of calculating optimum flight paths of communication relay UAVs and a dynamic data flow.

### DETAILED DESCRIPTION

Hereinafter, preferred embodiments are presented to help understanding of the present disclosure. However, the following embodiments are provided only to understand the present disclosure more easily, and the contents of the present disclosure are not limited by the embodiments.

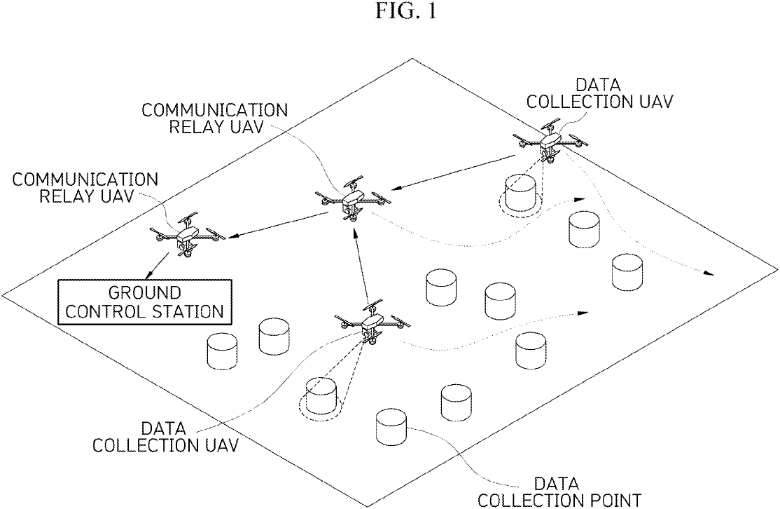

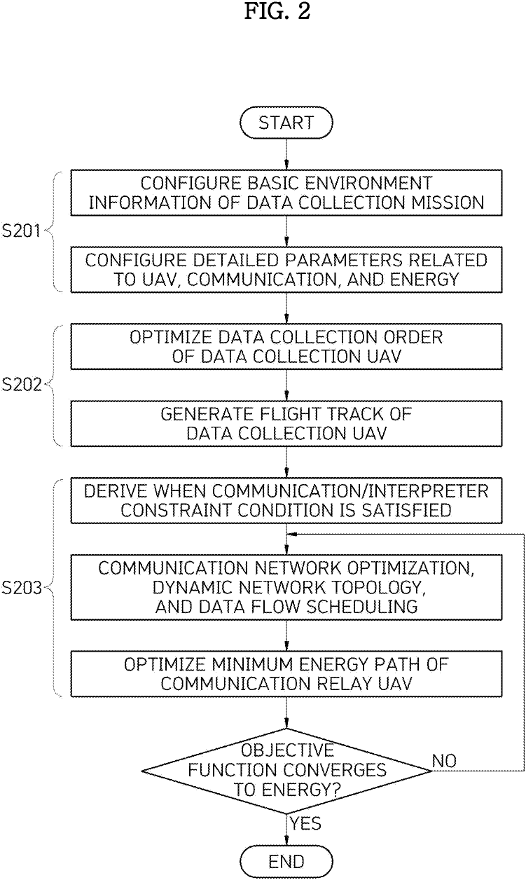

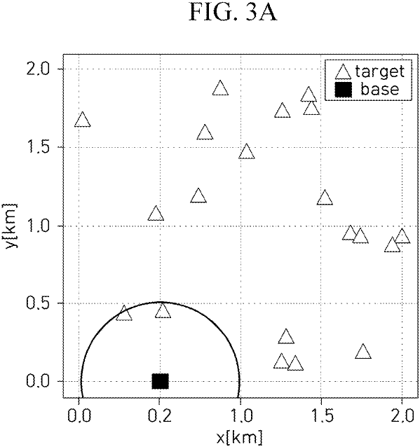

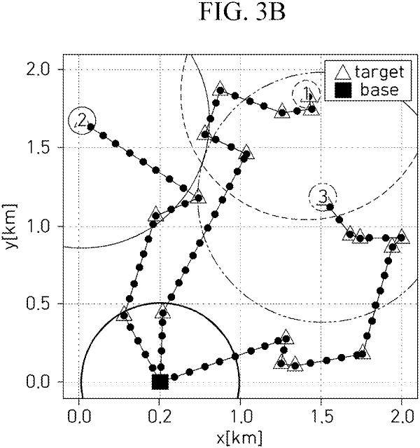

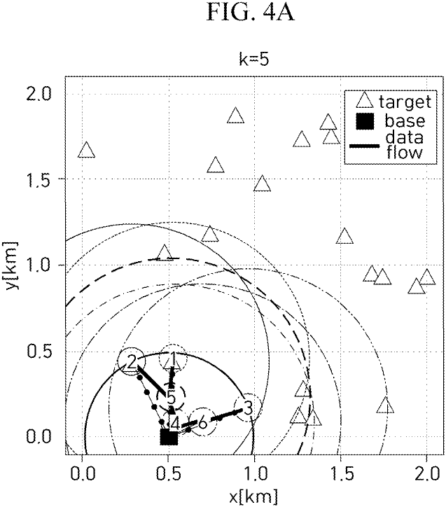

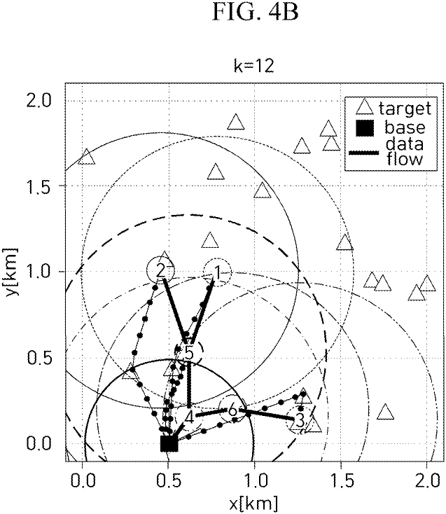

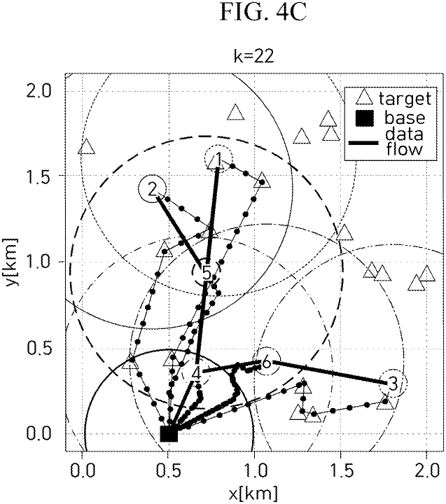

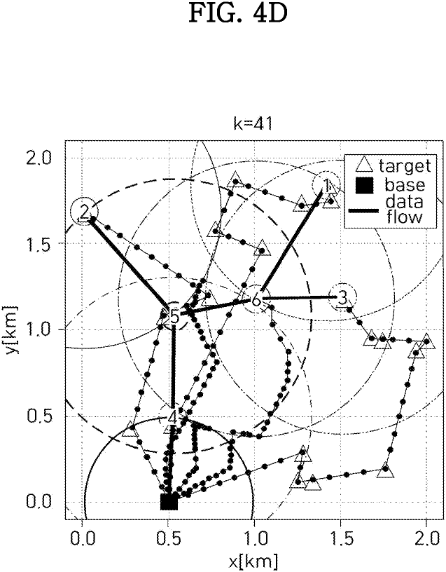

FIG. 1 is a diagram explaining the concept of a method for optimization of mission planning of a multi-UAV network for data collection and communication relay according to the present disclosure, FIG. 2 is a diagram illustrating a method for optimization of mission planning of a multi-UAV network for data collection and communication relay in sequential order according to the present disclosure, FIGS. 3A and 3B are a diagram illustrating a screen for generating flight paths of data collection UAVs, and FIGS. 4A, 4B, 4C and 4D are a diagram illustrating the results of calculating optimum flight paths of communication relay UAVs and a dynamic data flow.

First, referring to FIGS. 1 and 2, a method for optimization of mission planning of a multi-UAV network for data collection and communication relay according to the present disclosure performs: defining data collection mission information and parameters (S201); optimizing mission planning of a plurality of data collection UAVs (S202); and optimizing mission planning of a plurality of communication relay UAVs (S203).

Here, the data collection mission of the multi-UAV network is as follows.

Referring to FIG. 1, M “data collection points” are randomly distributed in a wide mission area that is difficult to be covered by one UAV. In this case, each of the data collection points may mean a UAV image photographing point, or a ground sensor device which performs unique environment data observation, but has a weak long-distance communication performance.

In order to effectively complete total M data collections in a limited flight time of UAVs during flight, X “data collection UAVs” are thrown. In this case, the respective data collection UAVs transmit data collected by them to a ground control station in real time.

In a poor communication environment in which it is difficult to utilize the existing communication infrastructure, it is difficult to effectively perform the UAV mission in a wide area only with the data collection UAVs having limited communicable distance. In this case, in order to increase a UAV mission performing area of the data collection UAVs, Y “communication relay UAVs” are additionally thrown.

That is, total N (=X+Y) multiple UAVs are thrown for data collection and relay.

The N multiple UAVs establish an ad-hoc communication network in order to maintain a real-time communication link with a ground control station located on the ground. The X data collection UAVs completes the data collection in the shortest possible time by efficiently determining flight paths for multiple data collection and data collection order, and the Y communication relay UAVs support multi-UAV ad-hoc communication network that minimizes energy consumption of the whole communication network.

Based on the concept as above, a method for optimization of mission planning of a multi-UAV network for data collection and communication relay according to the present disclosure will be described.

First, data collection mission information and parameters are defined (S201).

In this step, basic environment information of the data collection mission information is configured, and parameters among UAVs, communication, and energy are configured.

In particular, in the process of defining the data collection mission information and the parameters, the number of data collection UAVs and the number of communication relay UAVs are defined, the number and the locations of data collection points are defined, and a ground control station location is defined.

Next, the mission planning of the plurality of data collection UAVs is optimized (S202).

In this step, the data collection order of the data collection UAV having the minimum mission end time (or minimum flight distance) is determined, and the flight path to match this is generated. The data collection UAVs are thrown into a mission situation in which the number M of the data collection points is larger than the number X of the data collection UAVs.

Accordingly, the data collection points are properly divided and allocated to the respective data collection UAVs, and the respective data collection UAVs should effectively determine the visit order for the data collection points allocated to themselves.

In the present disclosure, in order to determine the effective mission allocation and the visit order, the visit order at the data collection point allocated for each data collection UAV is determined by applying a multi-vehicle routing problem solving algorithm (mVRP solver) in which X vehicles located in depots visit M nodes in all within the shortest distance.

For this, a process, in which the effective mission allocation and visit order determination problem is replaced by the multi-vehicle routing problem solving algorithm (mVRP solver), is performed, and the suboptimal solution of the problem replaced by the mVRP is found within a predetermined operation time through the multi-vehicle routing problem solving algorithm (mVRP solver).

In order to establish the mission planning of the multiple data collection UAVs, in the present disclosure, the flight path is generated based on the visit order for the data collection points obtained through the multi-vehicle routing problem solving algorithm (mVRP solver) as described above. The flight path of each data collection UAV is generated based on the maximum speed of the data collection UAV, decision time interval, and data collection time required. In this case, the flight path means set information of the location of each data collection UAV for each predetermined time unit or set information of the movement path of each data collection UAV. The flight paths of the respective data collection UAVs appear as in FIGS. 3A and 3B.

Next, the mission planning of the multiple communication relay UAVs is optimized (S203).

In this step, the mission planning of the communication relay UAVs for effectively transmitting large capacity data obtained by the multiple data collection UAVs to the ground base station in real time is established.

Referring to FIGS. 4A, 4B, 4C and 4D, in the present disclosure, the flight path of each of the data collection UAVs is calculated and determined to satisfy the minimum energy consumption based on the previously generated flight path of each of the data collection UAVs, the communication network topology is calculated, the dynamic data flow is scheduled, and further, the minimum energy path of each of the communication relay UAVs is optimized.

More specifically, in the present disclosure, the problem of finding the location for each time step of each communication relay UAV, speed, communication topology of the network of the entire communication relay UAVs, and bitrate for each communication link is divided and formalized into a mixed-integer linear programming (MILP) problem and a non-linear optimization problem.

The first MILP problem corresponds to a process of fixing the flight paths of the multiple communication relay UAVs and optimizing dynamic communication related variables having the minimum energy, and the second MILP problem corresponds to a process of optimizing the flight paths of the communication relate UAVs so that they become the minimum energy after fixing the communication network related variables of the multiple communication relay UAVs.

In this case, the above process is repeatedly performed until the total energy consumption that is the objective function converges to the predetermined energy amount, and the optimized flight paths of the communication relay UAVs and the data flow for the mission in which Y (=3) communication relay UAVs are thrown are generated as shown in FIGS. 4A, 4B, 4C and 4D based on the previously obtained flight paths of the data collection UAVs.

As described above, the multi-UAV network that is formed by the data collection UAVs and the communication relay UAVs has a very high mission planning complexity due to many UAV unique elements and communication related elements constituting the network. According to the existing technologies, only the mission planning for only the data collection UAVs is presented without the communication related elements, the existing technology is limited only to the UAV communication technology without considering the mission planning, or the mission planning technology of different multiple UAVs that are not connected to each other through the network is mainly handled.

Accordingly, through the present disclosure, it is possible to establish the multi-UAV network mission planning in which elements being fragmentarily handled by the existing technologies are comprehensively integrated, and the effective optimum mission planning can be derived by using only the optimization tool that can be obtained as an open source. In particular, through the present disclosure, it is possible to integrally performing the optimization of the flight paths and the data collection order of the data collection UAVs, the flight paths of the communication relay UAVs, the dynamic communication network topology, and the optimization of the high-capacity data transmission/reception bitrate scheduling, of which the technology in the related art is unable to take charge.

Although the preferred embodiments of the present disclosure have been described, a person skilled in the art to which the present disclosure pertains will be able to understand that the present disclosure may be variously modified and changed within the scope that does not deviate from the technical spirit or essential characteristics of the present disclosure described in the appended claims.

Each step included in the method described above may be implemented as a software module, a hardware module, or a combination thereof, which is executed by a computing device.

Also, an element for performing each step may be respectively implemented as first to two operational logics of a processor.

The devices, apparatuses, units, modules, and components described herein with respect to FIGS. 1-4D are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods that perform the operations described in this application, and illustrated in FIGS. 1-4D, are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller, e.g., as respective operations of processor implemented methods. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that be performed by the hardware components and the methods as described above. In one example, the instructions or software include machine code that is directly executed by the one or more processors or computers, such as machine code produced by a compiler. In another example, the instructions or software include higher-level code that is executed by the one or more processors or computers using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), EEPROM, RAM, DRAM, SRAM, flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors and computers so that the one or more processors and computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent to one of ordinary skill in the art, after an understanding of the disclosure of this application, that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method for optimization of mission planning of a multi-UAV network for data collection and communication relay, the method comprising:
defining data collection mission information and parameters;
optimizing mission planning of a plurality of data collection UAVs; and
optimizing mission planning of a plurality of communication relay UAVs.

2. The method of claim 1, wherein the defining the data collection mission information and the parameters comprises:
configuring basic environment information of the data collection mission information; and
configuring a variable among the UAV, communication, and energy.

3. The method of claim 2, wherein the defining the data collection mission information and the parameters comprises:
defining the number of the data collection UAVs and the communication relay UAVs;
defining the number and locations of data collection points; and
defining a location of a ground control station.

4. The method of claim 1, wherein the optimizing the mission planning of the plurality of data collection UAVs comprises:
determining a data collection order of each of the data collection UAVs based on a minimum mission end time or a minimum flight distance of the data collection UAV; and
generating a flight path of each of the data collection UAVs in accordance with a determined data collection order.

5. The method of claim 4, wherein the determining the data collection order of each of the data collection UAVs based on the minimum mission end time or the minimum flight distance of the data collection UAV comprises:
determining a visit order of allocated data collection points for each of the data collection UAVs by applying a multi-vehicle routing problem solving algorithm (mVRP solver).

6. The method of claim 4, wherein the generating the flight path of each of the data collection UAVs in accordance with the determined data collection order comprises:
generating the flight path of each of the data collection UAVs based on a maximum movement speed, a decision making time interval, and a required data collection time of each of the data collection UAVs.

7. The method of claim 6, wherein the flight path is set information of locations of each of the data collection UAVs for each predetermined time unit or set information of movement path points of each of the data collection UAVs.

8. The method of claim 4, wherein the optimizing the mission planning of the plurality of data collection UAVs comprises:
calculating and determining a flight path of each of the data relay UAVs so as to satisfy a minimum energy consumption based on the generated flight path of each of the data collection UAVs, calculating a communication network topology, and scheduling a dynamic data flow; and
optimizing a minimum energy path of each of the communication relay UAVs.

9. The method of claim 8, wherein the calculating and determining the flight path of each of the data relay UAVs so as to satisfy the minimum energy consumption based on the generated flight path of each of the data collection UAVs, calculating the communication network topology, and scheduling the dynamic data flow comprises:
dividing and formalizing a problem into a mixed-integer linear programming (MILP) problem and a non-linear optimization problem.

10. The method of claim 9, wherein the dividing and formalizing the problem into the mixed-integer linear programming (MILP) problem and the non-linear optimization problem comprises:
fixing the flight path of each of the communication relay UAVs, and determining a dynamic communication network variable having the minimum energy consumption;
fixing a dynamic communication network of each of the communication relay UAVs, and determining a flight path having the minimum energy consumption; and
repeating the determining the dynamic communication network variable and the determining the flight path.

11. The method of claim 10, wherein the optimizing the mission planning of the plurality of communication relay UAVs further comprises;
visualizing as a graph and outputting the result of the repeating the determining the dynamic communication network variable and the determining the flight path.

12. A system for optimization of mission planning of a multi-UAV network for data collection and communication relay, the system comprising:
a mission information definer configured to define data collection mission information and parameters;
a data collection UAV mission planning optimizer configured to optimize mission planning of a plurality of data collection UAVs; and
a communication relay UAV mission planning optimizer configured to optimize mission planning of a plurality of communication relay UAVs.

13. The system of claim 12, wherein the plurality of communication relay UAVs are connected to one another in a row, the communication relay UAV at a first location is connected to a ground control station, and the communication relay UAV at a last location is individually connected to a cluster composed of the plurality of data collection UAVs.

14. The system of claim 12, wherein the plurality of data collection UAVs and the plurality of communication relay UAVs communicate with each other based on an ad-hoc network.

15. A system for optimization of mission planning of a multi-UAV network for data collection and communication relay, the system comprising:
a mission information definer configured to define data collection mission information and parameters;
a data collection UAV mission planning optimizer configured to optimize mission planning of a plurality of data collection UAVs communicating with each other based on an ad-hoc network; and
a communication relay UAV mission planning optimizer configured to optimize mission planning of a plurality of communication relay UAVs communicating with each other based on the ad-hoc network.
